(19) United States
(12) Patent Application Publication
(10) Pub. No.: US 2014/0099407 A1
(43) Pub. Date: Apr. 10, 2014

(54) Compound Coating Containing Coffee & Snack Food Products Using Same

(71) Applicant: FRITO-LAY NORTH AMERICA, INC., Plano, TX (US)

(72) Inventors: Andres Victor ARDISSON-KORAT, Dallas, TX (US); Jennifer Bell RAYMOND, Plano, TX (US); R. Todd SMITH, Plano, TX (US); Alex TIPTON, Plano, TX (US); Louis C. VAZQUEZ, Plano, TX (US)

(73) Assignee: FRITO-LAY NORTH AMERICA, INC., Plano, TX (US)

(21) Appl. No.: 13/646,193

(22) Filed: Oct. 5, 2012

(51) Int. Cl. A23L 1/00

(52) U.S. Cl. CPC A23L 1/005
USPC 426/94; 426/93; 426/293

(57) ABSTRACT

The present invention is directed to a compound coating compound containing coffee powder that delivers the substantial equivalent as a cup of coffee in about one to about three ounces of food product. The compound coating may be used in many different snack food products, providing an additional source of energy for the consumer. A method for making a snack food product with the compound coating is also disclosed.

### BACKGROUND OF THE INVENTION

1. Technical Field

The present invention relates to a compound coating containing coffee powder for snack food products and snack food products made with the compound coating.

2. Description of Related Art

Coffee is a popular beverage in part because coffee provides the effect of warding off drowsiness and restoring alertness. Although many people enjoy coffee, some find the bitter taste undesirable. Coffee beans covered with chocolate are a popular food product designed to deliver the experience of coffee while taking advantage of the flavor and desirability of chocolate. However, they are usually only slightly sweet, and the intense, bitter flavor of the coffee beans can be overwhelming for non-coffee-drinkers. Thus, it is desirable to make a snack food product that delivers the experience of coffee but only has a slight bitter flavor, if any, from the coffee.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart indicating the processing steps for one embodiment of the present invention.

### DETAILED DESCRIPTION OF THE INVENTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

The present invention is directed to a compound coating containing coffee powder for snack food products that delivers the experience of coffee to the consumer in snack food form. As used herein, the term “coffee powder” means the powder from which liquid coffee is made by adding water. The compound coating may be used in many different snack food products, providing an additional source of energy for the consumer. The goal in developing the compound coating was to deliver the substantial equivalent as a cup of coffee in about one to about three ounces of food product while masking the bitter flavor of the coffee to make the product palatable to consumers.

One consideration in choosing the coffee powder for inclusion in the compound coating is the overall flavor profile of the coffee. Coffee naturally has a bitter taste, but one goal in developing the compound coating is to decrease or limit the bitterness in the final compound coating. Thus, it is preferable to choose a coffee with minimal bitter flavor and aftertaste. In one embodiment, a coffee source with low to mild roasted notes and low bitterness is used to produce a mild coffee profile in the final coating. In another embodiment, instant coffee is used because the desired experience of coffee can be achieved while using two to three times less the amount of coffee powder in the final compound coating.

Another consideration in choosing the coffee powder is the particle size of the coffee powder. The particle size of the coffee powder affects the grittiness in the final coating; thus, coffee powders with a smaller particle size distribution are preferred. In one embodiment, spray-dried coffee powder is used instead of freeze-dried coffee powder due to its smaller particle size distribution.

Regardless of the coffee powder used, there will be a bitter flavor to the compound coating due to coffee's natural bitterness. Choosing a coffee powder with low bitter notes as described above lessens the degree of the bitterness. Another way to offset or mask the bitter flavor is to add a bitter masker to the compound coating. As used herein, a “bitter masker” is an ingredient or ingredients chosen to mitigate the bitter flavor and aftertaste that the coffee produces. In one embodiment, the bitter masker used is a compound containing mixed triglycerides and natural flavoring. Additionally, a topical seasoning may be applied to the final snack product using the compound coating to further mask any remaining bitter aftertaste that the bitter masker does not effectively mitigate. The topical seasoning may comprise any ingredients known in the art that complement the compound coating and help mask the bitter flavor of the coffee in the coating. In one embodiment, the topical seasoning comprises one or more ingredients selected from sugar, brown sugar, dextrose, molasses, lactose, cocoa powder, cocoa powder processed with alkali, sunflower oil, corn oil, canola oil, modified corn starch, corn starch, corn maltodextrin, butter powder, cream powder, flavors and gum arabic.

The compound coating flavor may be flavor known in the art such as chocolate, white chocolate, peanut butter or caramel. Standard compound coating technology allows the addition of coffee powder to a compound coating in an amount of about 5% to about 20% by weight of the total compound coating without adversely affecting the coating properties of melt viscosity and ability to set. In one embodiment, the amount of coffee added to the compound coating is sufficient to deliver the substantial equivalent of a cup of coffee, or about 1.5 grams to about 3 grams of coffee powder, in about one to about three ounces of the snack food product using the compound coating. In one embodiment, coffee powder is added to the compound coating in an amount of about 5% to about 12% by weight of the total compound coating. In another embodiment, coffee powder is added to the compound coating in an amount of about 8% to about 10% by weight of the total compound coating. In yet another embodiment, the amount of coffee added to the compound coating is sufficient to deliver the substantial equivalent of a cup of coffee, or about 2 grams to about 2.4 grams of coffee powder, in about two ounces of the snack food product using the compound coating. Those skilled in the art will understand that the coffee flavor and overall flavor of the compound coating may be manipulated by varying the amounts of coffee powder and other ingredients added to the compound coating mixture.

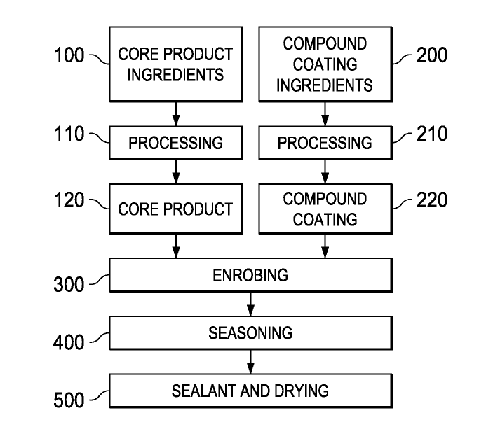

The compound coating containing coffee powder of the present invention may be used to coat or enrobe a core product to make a finished snack food product. As used herein, the term “core product” means any low water activity product, such as cookies, pretzels, granola clusters, granola bars, wafers, nuts, corn chips, potato chips, or wheat chips. FIG. 1 is a flowchart showing the processing steps involved in one embodiment of making a finished snack food with the inventive compound coating. The core product ingredients 100 are processed 110 by any means known in the art to form the core product 120. In a separate processing stream, the compound coating ingredients 200, including the coffee powder, are processed 210 to make the compound coating 220. The core product 120 is then enrobed 300 by the compound coating compound 220 to make a snack food product. The snack food product is then seasoned 400 with a topical seasoning, a sealant is applied to the snack food product and the snack product is dried 500.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Additional Disclosure:

1. A snack food product comprising a compound coating, wherein said compound coating comprises coffee powder, wherein about one to about three ounces of said snack food product comprises about 1.5 grams to about 3.0 grams of coffee powder.
2. The snack food product of any preceding claim wherein said compound coating comprises about 5% to about 20% coffee powder by weight of the total compound coating.
3. The snack food product of any preceding claim wherein said coffee powder comprises instant coffee.
4. The snack food product of any preceding claim wherein said coffee powder comprises spray dried coffee.
5. The snack food product of any preceding claim further comprising a bitter masker.
6. The snack food product of any preceding claim wherein about two ounces of said snack food product comprises about 2.0 grams to about 2.4 grams of coffee powder.
7. The snack food product of any preceding claim wherein said compound coating comprises about 5% to about 12% coffee powder by weight of the total compound coating.
8. The snack food product of any preceding claim wherein said compound coating comprises about 8% to about 10% coffee powder by weight of the total compound coating.
9. The snack food product of any preceding claim wherein said compound coating is chocolate flavored.
10. A snack food product comprising:
   a core product; and
   a compound coating enrobing said core product, wherein said compound coating comprises coffee powder; and
   a topical seasoning,
   wherein about one to about three ounces of said snack food product comprises about 1.5 grams to about 3.0 grams of coffee powder.
11. The snack food product of any preceding claim wherein said compound coating comprises about 5% to about 20% coffee powder by weight of the total compound coating.
12. The snack food product of any preceding claim wherein said topical seasoning comprises one or more ingredients selected from the group consisting of sugar, brown sugar, dextrose, molasses, lactose, cocoa powder, cocoa powder processed with alkali, sunflower oil, corn oil, canola oil, modified corn starch, corn starch, corn maltodextrin, butter powder, cream powder, flavors and gum arabic.
13. The snack food product of any preceding claim wherein said core product comprises a low water activity product.
14. The snack food product of any preceding claim wherein said core product is selected from the group consisting of a cookie, wafer, pretzel, granola cluster, granola bar, nuts, corn chip, potato chip or wheat chip.
15. The snack food product of any preceding claim wherein said coffee powder comprises instant coffee.
16. The snack food product of any preceding claim wherein said coffee powder comprises spray dried coffee.
17. The snack food product of any preceding claim wherein said compound coating further comprises a bitter masker.
18. The snack food product of any preceding claim wherein about two ounces of said snack food product comprises about 2.0 grams to about 2.4 grams of coffee powder.
19. The snack food product of any preceding claim wherein said compound coating comprises about 5% to about 12% coffee powder by weight of the total compound coating.
20. The snack food product of any preceding claim wherein said compound coating comprises about 8% to about 10% coffee powder by weight of the total compound coating.
21. The snack food product of any preceding claim wherein said compound coating is chocolate flavored.
22. A method of producing a snack food product, said method comprising:
   providing a core product;
   providing a compound coating, wherein said compound coating comprises coffee powder;
   enrobing said core product in said compound coating to make a snack food product;
   seasoning said snack food product with a topical seasoning;
   applying a sealant to said snack food product; and
   drying said snack food product,
   wherein about one to about three ounces of said snack food product comprises about 1.5 grams to about 3.0 grams of coffee powder.
23. The method of any preceding claim wherein said compound coating comprises about 5% to about 20% coffee powder by weight of the total compound coating.
24. The method of any preceding claim wherein said core product comprises a low water activity product.
25. The method of any preceding claim wherein said core product is selected from the group consisting of a cookie, wafer, pretzel, granola cluster, granola bar, nuts, corn chip, potato chip or wheat chip.
26. The method of any preceding claim wherein said topical seasoning comprises one or more ingredients selected from the group consisting of sugar, brown sugar, dextrose, molasses, lactose, cocoa powder, cocoa powder processed with alkali, sunflower oil, corn oil, canola oil, modified corn starch, corn starch, corn maltodextrin, butter powder, cream powder, flavors and gum arabic.
27. The method of any preceding claim wherein said coffee powder comprises instant coffee.
28. The method of any preceding claim wherein said coffee powder comprises spray dried coffee.
29. The method of any preceding claim wherein said chocolate coating further comprises a bitter masker.
30. The method of any preceding claim wherein about two ounces of said snack food product comprises about 2.0 grams to about 2.4 grams of coffee powder.
31. The method of any preceding claim wherein said compound coating comprises about 5% to about 12% coffee powder by weight of the total compound coating.
32. The method of any preceding claim wherein said compound coating comprises about 8% to about 10% coffee powder by weight of the total compound coating.
33. The method of any preceding claim wherein said compound coating is chocolate flavored.

1. A snack food product comprising a compound coating, wherein said compound coating comprises coffee powder, wherein two of said snack food product comprises 2.0 grams to 2.4 grams of coffee powder.

2. The snack food product of claim 1 wherein said compound coating comprises about 5% to about 20% coffee powder by weight of the total compound coating.

3. The snack food product of claim 1 wherein said coffee powder comprises instant coffee.

4. The snack food product of claim 1 wherein said coffee powder comprises spray dried coffee.

5. The snack food product of claim 1 further comprising a bitter masker.

6. (canceled)

7. The snack food product of claim 1 wherein said compound coating comprises about 5% to about 12% coffee powder by weight of the total compound coating.

8. The snack food product of claim 1 wherein said compound coating comprises about 8% to about 10% coffee powder by weight of the total compound coating.

9. The snack food product of claim 1 wherein said compound coating is chocolate flavored.

10. A snack food product comprising:
a core product; and
a compound coating enrobing said core product, wherein said compound coating comprises coffee powder; and
a topical seasoning,
wherein two ounces of said snack food product comprises 2.0 grams to 2.4 grams of coffee powder.

11. The snack food product of claim 10 wherein said compound coating comprises about 5% to about 20% coffee powder by weight of the total compound coating.

12. The snack food product of claim 10 wherein said topical seasoning comprises one or more ingredients selected from the group consisting of sugar, brown sugar, dextrose, molasses, lactose, cocoa powder, cocoa powder processed with alkali, sunflower oil, corn oil, canola oil, modified corn starch, corn starch, corn maltodextrin, butter powder, cream powder, vanilla flavor, natural flavors, artificial flavors and gum arabic.

13. (canceled)

14. The snack food product of claim 10 wherein said core product is selected from the group consisting of a cookie, wafer, pretzel, granola cluster, granola bar, nuts, corn chip, potato chip or wheat chip.

15. The snack food product of claim 10 wherein said coffee powder comprises instant coffee.

16. The snack food product of claim 10 wherein said coffee powder comprises spray dried coffee.

17. The snack food product of claim 10 wherein said compound coating further comprises a bitter masker.

18. (canceled)

19. The snack food product of claim 10 wherein said compound coating comprises about 5% to about 12% coffee powder by weight of the total compound coating.

20. The snack food product of claim 10 wherein said compound coating comprises about 8% to about 10% coffee powder by weight of the total compound coating.

21. The snack food product of claim 10 wherein said compound coating is chocolate flavored.

22. A method of producing a snack food product, said method comprising:
providing a core product;
providing a compound coating, wherein said compound coating comprises coffee powder;
enrobing said core product in said compound coating to make a snack food product;
seasoning said snack food product with a topical seasoning;
applying a sealant to said snack food product; and
drying said snack food product,
wherein two ounces of said snack food product comprises 2.0 grams to 2.4 grams of coffee powder.

23. The method of claim 22 wherein said compound coating comprises about 5% to about 20% coffee powder by weight of the total compound coating.

24. (canceled)

25. The method of claim 22 wherein said core product is selected from the group consisting of a cookie, wafer, pretzel, granola cluster, granola bar, nuts, corn chip, potato chip or wheat chip.

26. The method of claim 22 wherein said topical seasoning comprises one or more ingredients selected from the group consisting of sugar, cocoa powder and flavors sugar, brown sugar, dextrose, molasses, lactose, cocoa powder, cocoa powder processed with alkali, sunflower oil, corn oil, canola oil, modified corn starch, corn starch, corn maltodextrin, butter powder, cream powder, vanilla flavor, natural flavors, artificial flavors and gum arabic.

27. The method of claim 22 wherein said coffee powder comprises instant coffee.

28. The method of claim 22 wherein said coffee powder comprises spray dried coffee.

29. The method of claim 22 wherein said chocolate coating further comprises a bitter masker.

30. (canceled)

31. The method of claim 22 wherein said compound coating comprises about 5% to about 12% coffee powder by weight of the total compound coating.

32. The method of claim 22 wherein said compound coating comprises about 8% to about 10% coffee powder by weight of the total compound coating.

33. The method of claim 22 wherein said compound coating is chocolate flavored.
